(19) United States
(12) Patent Application Publication
(10) Pub. No.: US 2003/0172377 A1
(43) Pub. Date: Sep. 11, 2003

(54) Method and apparatus for selectively accessing programs in a parental control system

(76) Inventor: Carolynn Rae Johnson, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/090,668

(22) Filed: Mar. 5, 2002

(51) Int. Cl. H04N 7/16; H04N 5/445

(52) U.S. Cl. 725/25; 725/53

(57) ABSTRACT

A rating limit is set corresponding to first user input and an exception to the rating limit is set corresponding to a second user input. Information for specifying the rating of a program and for identifying the program is received. The rating is compared with the stored rating limit and it is determined using the information for identifying the program whether an exception from the rating limit for the program has been set. Access to the program is controlled in response to the results of the comparing and checking of the received information.

### FIELD OF THE INVENTION

The invention relates to a method and an apparatus for selectively accessing programs in a parental control system.

### BACKGROUND OF THE INVENTION

Television broadcasts may contain content that could be harmful to children like violence or sexual content. Therefore, various parental control systems have been developed for blocking inappropriate programs or channels.

In the U.S. a blocking system has been employed for television content advisories (ratings) using the so-called V-chip. The ratings are encoded by the broadcaster during the vertical blanking period of an NTSC television signal, more specifically during line 21 of field 2, using a data format referred to as Extended Data Services or XDS. The XDS data format is similar to the format of closed caption data in the U.S. which is encoded in line 21 of field 1 of an NTSC television signal. The data formats for both XDS and closed caption information are specified in the EIA-608 standard developed by the Consumer Electronics Association (CEA) in the U.S. The rating signal is transmitted together with the respective TV show and detected by the V-chip system implemented in the TV apparatus. The system decodes the line 21 data, compares it with the allowed rating and then either blocks the signal or lets it through. Note that references herein to TV apparatus, TV systems, TV set, and/or video signal processing systems or apparatus are intended to encompass any system, either with or without a display device, for processing a video or TV signal that includes auxiliary information, such as XDS data, for providing ratings information. Examples of such systems include televisions, VCR, DVD, satellite signal receiver, set-top boxes, cable boxes, etc.

A system such as V-Chip requires parents to identify the ratings they wish to block on two different rating systems: the TV Parental Guidelines, and the Motion Picture Association of America (MPAA) movie ratings, which are used on unedited movies shown on premium cable channels. The TV Parental Guidelines consist of an age-based rating that indicates the age group for which a particular program is considered suitable and a content-based rating. The MPAA movie ratings are also divided into age groups but differ from the above mentioned television ratings.

The setting up of the rating limits is usually done by means of onscreen directions offered for the two separate ratings systems. For example, for movie ratings the user may highlight “PG-13” indicating that all programs above this rating should be blocked, and all programs below this rating should be deemed acceptable. For the TV rating limits the user also has to select an age-based rating, e.g. “TV-14”. In addition, for TV rating limits the user must also determine whether to block certain types of content, wherein the content-based rating may be defined differently for the various age-based ratings.

Another capability that can be provided within a parental control system is disclosed in U.S. Pat. No. 5,949,471. This system allows the user to enable a V-block mode which blocks offending scenes from viewing, to select particular programs to be blocked from viewing or to specify all programs on a particular channel to be blocked. A particular program is blocked based on the channel, date, time-of-date and length of this program, which can be entered by the user as a compressed code.

### SUMMARY OF THE INVENTION

The invention is based on the recognition of the following fact. When a user establishes rating limits to control the programming that the children are permitted to view, the user is forced to rely on the MPAA rating, TV rating or content ratings, given to that program by the broadcasters. However, there may be some programs that the user would prefer his or her children did not watch, even though the rating level given to that program might normally be acceptable to the user. Likewise, there may be programs that the user deems acceptable for viewing by the children, even though the rating given to that program might normally be a cause for concern for the user.

Therefore, according to an embodiment of the invention rating limits are set corresponding to first user inputs. Furthermore, exceptions from said rating limits are set corresponding to second user inputs. Both, the rating limits and the exceptions from said rating limits are stored. Information for specifying the rating of a program and for identifying the program is received. The rating is compared with the stored rating limits and it is checked with the information for identifying the program whether an exception from the rating limit for the program has been set. Access to said program is allowed depending on the results of the comparing and checking of the received information.

### BRIEF DESCRIPTION OF THE DRAWINGS

Exemplary embodiments of the invention are described on the basis of the drawings, in which

FIG. 1: is a high level block diagram of an apparatus suitable of selectively blocking the viewing of television programs;

FIG. 2: is a flow diagram of a method for the set-up of rating exceptions;

FIG. 3: is a flow diagram of a method for selectively blocking or enabling the viewing of television programs;

FIG. 4: is an on-screen display of an introduction into the Never Block Program List set-up;

FIG. 5: is an on-screen display of an introduction into the Always Block Program List setup;

FIG. 6: is an on-screen display of an Always Block Program List;

FIG. 7: is an on-screen display for entering an additional program to the Always Block Program List;

FIG. 8: is an on-screen display for removing a program from the Always Block Program List;

FIG. 9: is an on-screen display of a Never Block Program List;

FIG. 10: is an on-screen for unlocking the system in the case of a blocked program.

### DETAILED DESCRIPTION OF PREFERRED EMBODIMENTS

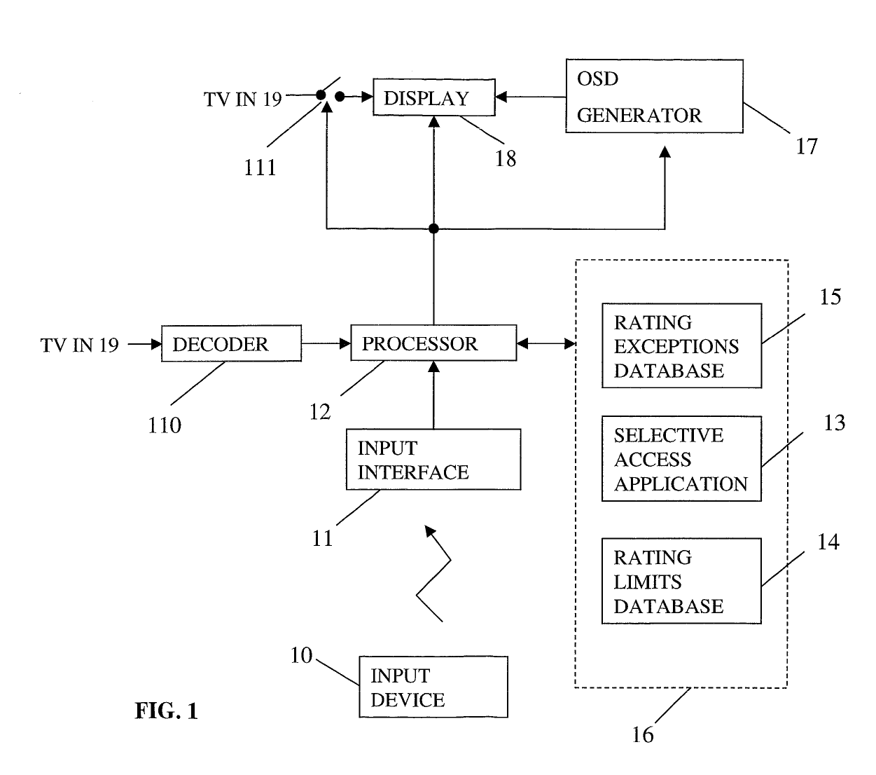

FIG. 1 depicts a high-level block diagram of an embodiment suitable of selectively blocking the viewing of television programs, implemented in a receiver device, e.g. in a TV set or set top box. Only parts relevant for the invention are described, while usual components like a tuner or demodulator are not shown.

The TV signal may be received in an arbitrary way, e.g. terrestrial, via cable, satellite or Internet in the case of a broadcasted signal. However, the TV signal may also be received from a playback device like a VCR, DVD player or the like.

An input device 10 allows calling up the feature for setting up rating limits and exceptions of these rating limits. The input device 10 may be any device utilized to provide input to devices like TV sets, set top boxes, computers etc. Examples of the input device 10 include a remote control, a keypad, a computer mouse, a microphone, a touch screen, and the like. An input interface 11 enables the processor 12 to receive commands from the input device 10. In response to a command starting the rating limits feature the processor 12 executes instructions in order to provide on-screen displays and to allow user inputs as described later on. The data for the display of the on-screen displays are supplied to the onscreen display generator 17 for generating the respective screen displays, which are displayed on a display device 18, e.g. the television screen.

Besides the setting of rating limits, which are stored in a rating limits database 14, the selective access application 13 allows also entering exceptions to the rating limits which are stored in a rating exceptions database 15.

The selective access application 13, the rating limits database 14 and the rating exceptions database 15 may be stored in the same memory device 16 but also in a combination of memory devices including random access memories (RAM), non-volatile or backup memories (e.g. programmable or flash memories), read only memories (ROM), and the like.

An incoming TV signal 19 is fed to a decoder 110, which separates and decodes data representing the recommended rating and data identifying the currently running program from the TV signal. For an analog TV signal both data can be transmitted in the Vertical Blanking Interval, e.g. as Extended Data Services data as specified in the EIA-608 standard. For a digital. TV signal the data may be included in service information which is transmitted in addition to the video and audio signal, e.g. according to the MPEG 2 systems standard.

The data are supplied to the processor 12, which compares the recommended ratings with the rating limits stored in the rating limits database 14 and checks with the information identifying the current program whether an exception from the rating limits is stored in the rating exceptions database 15. As a result the processor 12 blocks the display of the TV signal 19 as symbolized by switch 111, if either the rating limits indicate that the specific television program is to be blocked and no exception from the rating limits for said specific television program is set or the exception from said rating limits indicate that said specific television program is to be blocked. In the same way processor 12 enables the viewing of a television program if either the rating limits indicate that a specific television program is not to be blocked and no exception from said rating limits for said specific television program is set or an exception from said rating limits indicate that the specific television program is not to be blocked.

The exceptions indicating that particular television programs are to be enabled for viewing are included in a so-called Never Block Program List. This list allows the user to specify certain programs that should never be blocked by the system from viewing, even if these programs exceed the rating limits that were previously established by the user in the Movie Rating Limits and TV Rating Limits screens. For example, though the user may establish a rating limit such that all programs rated above TV-PG be blocked from viewing by the users of the system, the user may decide that the program Will & Grace, which is rated TV-14, is acceptable for viewing by those users. If the user subsequently adds the program Will & Grace to the Never Block Program List the system will not block any episodes of that program. Therefore, the user is not required to be present and to enter a password to unlock the system for viewing each time an episode of the program Will & Grace is aired.

The exceptions indicating that particular television programs are to be blocked are included in a complementary feature, called in the following the Always Block Program List. This list allows the user to specify certain programs that shall always be blocked by the system from viewing by the users of the system, even if these programs do not exceed the rating limits that were previously established by the user in the Movie Rating Limits and TV Rating Limits screens. For example, though the user may establish a rating limit such that all program rated TV-14 and below are viewable, the user may decide that the programs Dark Angel, Angel, and CSI, all rated TV-14, are too violent and would prefer that his or her children did not view these programs. If the user subsequently adds these programs to the Always Block Program List the system will always block all episodes of these programs.

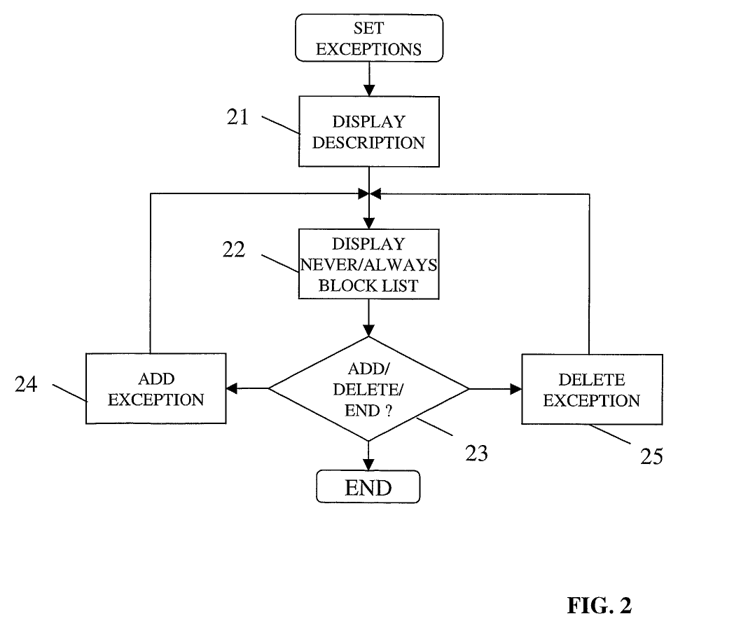

FIG. 2 shows a flow diagram of a method for the set-up of rating exceptions. A user being in the process of creating rating limits is also presented with the options of creating a Never Block List of programs and an Always Block List of programs. At step 21 the system displays a description of the feature and an explanation of its usage. After selecting the Never Block List or Always Block List, a list of items that have already been added to the respective list is presented to user in step 22. Depending on the user selection detected, the method may proceed in step 23 along various paths. A program may be added to the list in step 24 or deleted from this list in step 25, followed by a return of the method to step 22. When no more programs shall be added or removed, amending the Never/Always Block List is ended and the method may return to method step 21 or exit the rating limits feature.

The method of FIG. 2 is discussed in more detail in the following by the respective screens displayed at the various method steps.

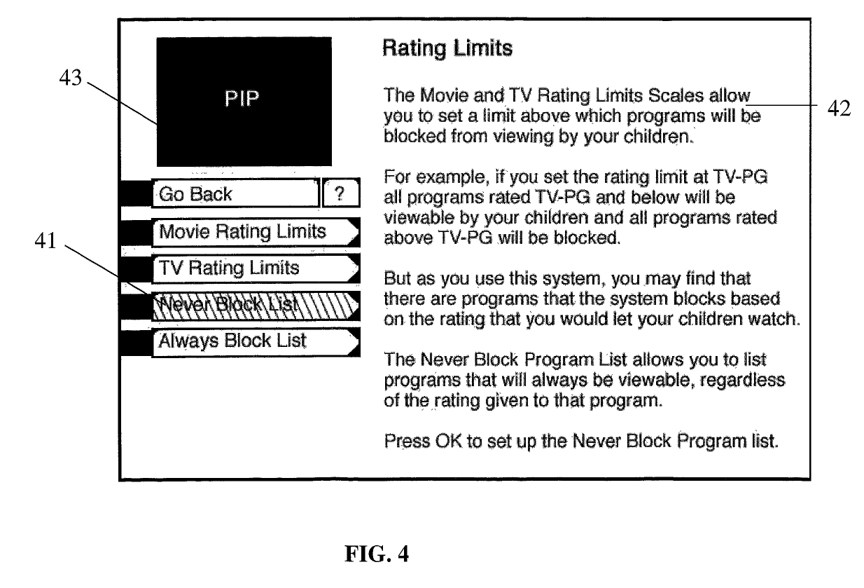

If the user selects the Never Block List feature, the system displays at step 21 the screen shown in FIG. 4. In a list of menu features 41 the selected feature “Never Block List” is highlighted. A description of the highlighted feature and an explanation of its usage 42 are displayed. Furthermore, the video signal of the former viewed channel may still be displayed as a PIP 43. In order to start setting up the Never Block List or Always Block List the user has to press an “OK” button. However, the user can also select to quit the set-up or to enter the standard modes for creating Movie rating limits and TV rating limits.

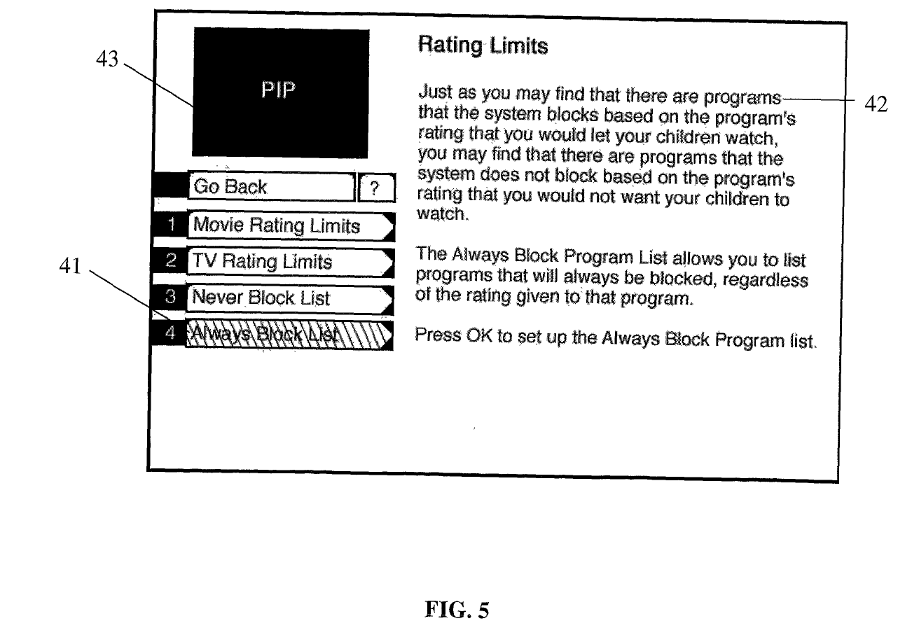

A similar screen is displayed if the user selects the Always Block List feature at step 21, as can be seen in FIG. 5. In the list of menu features 41 now the “Always Block List” is highlighted and is correspondingly described.

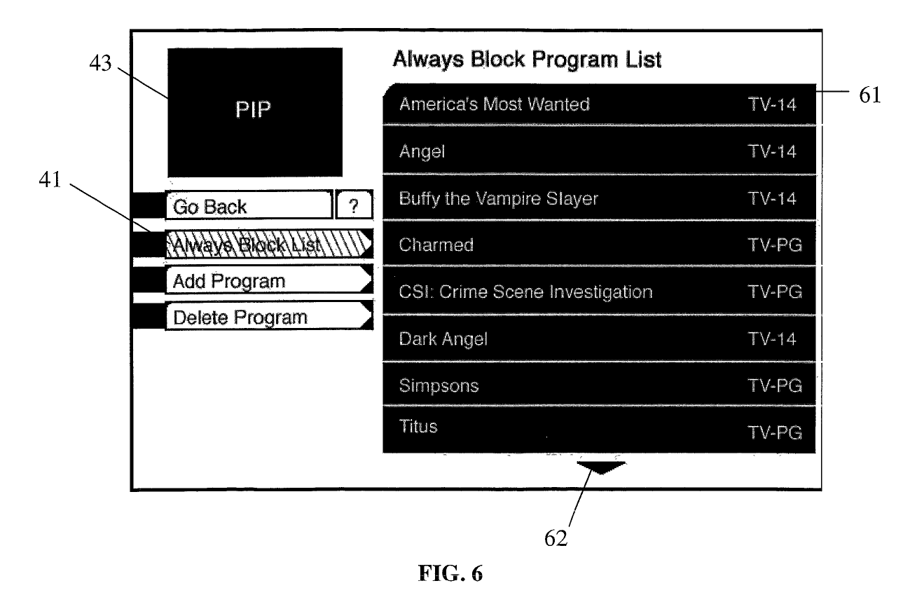

If the user highlighted and selected the Always Block List option, a list of items 61 that have already been added to the Always Block Program List is presented to the user for review or amendment, as shown in FIG. 6. A continuation symbol 62 may also be shown, if there are more items in the list than can be displayed on the screen. In this case the user may scroll through the list using up- and down-keys on the input device, e.g. the remote control. On the other hand, if the user had not yet added any programs to the Always Block Program List, the display area on the right would be empty, and the user would only have the option of adding programs to this list.

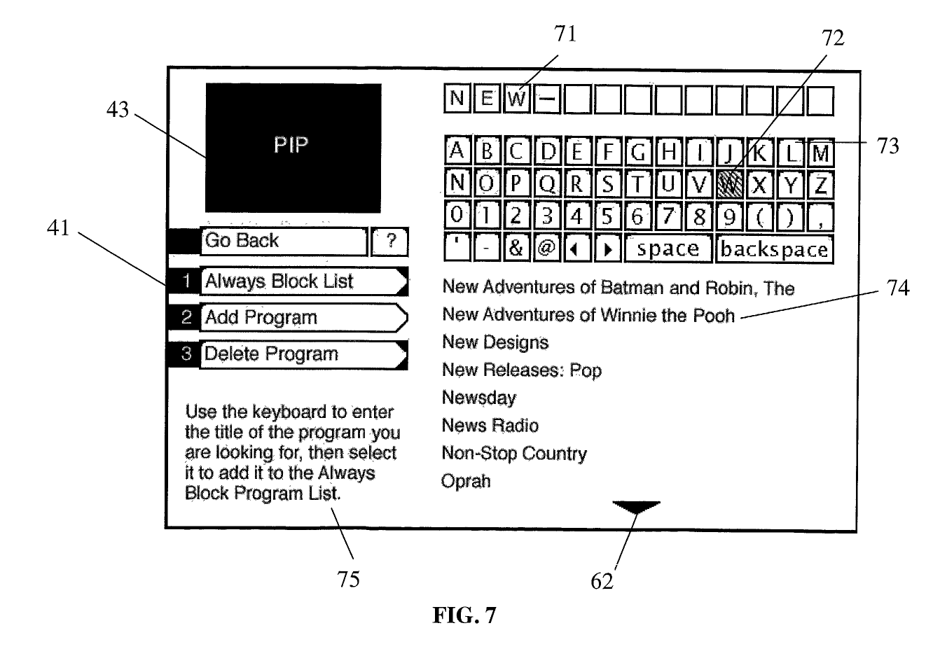

From this screen the user has the options to add a program to this list and to delete a program from this list. Should the user select the option Add Program in FIG. 6, the user would be presented in step 24 with a screen similar to that seen in FIG. 7. This screen would allow the user to enter the first few characters 71 of a title in the text spaces by highlighting and selecting letters 72 in the onscreen keyboard 73. When the user enters a letter in the first text field, the display area 74 shows programs whose titles begin with the selected letter, derived e.g. from a program information database such as an electronic program guide (EPG) database. If the user enters another letter, the display area changes to show programs whose titles begin with both of the selected letters. When the program that the user desires to add to the Always Block Program List appears in the display area 74, the user would then navigate to, highlight and select the desired program. Upon selecting the desired program, the system will go back to step 22, showing the screen seen in FIG. 6 with the newly blocked program added to the list seen in the display area. For the convenience of the user the screen shown in FIG. 6 may also comprise a short description of the usage 75.

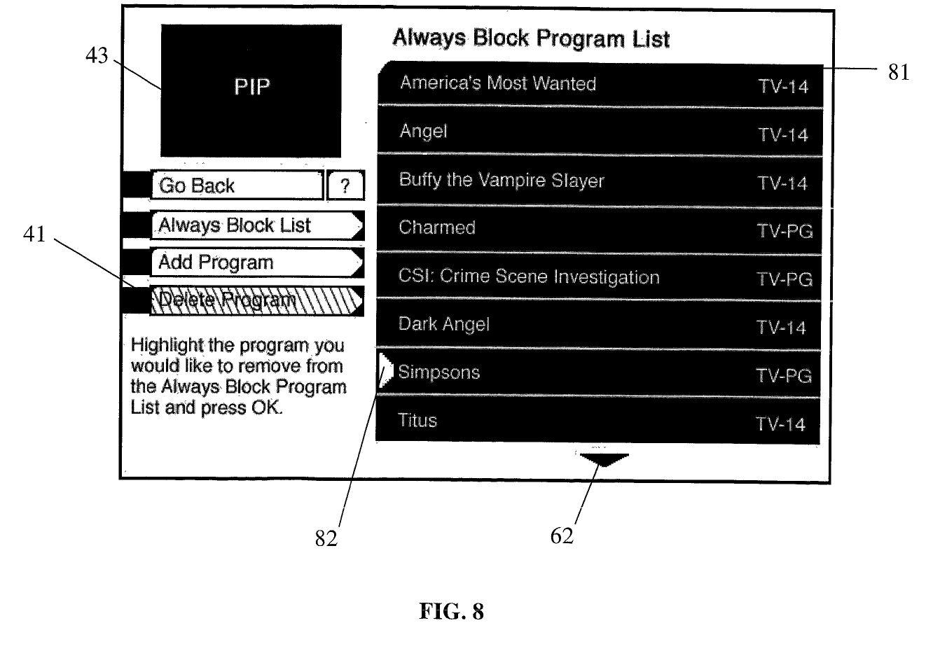

Should the user select the option Delete Program in FIG. 6, the system will proceed to step 25, where the user is presented with a screen similar to that seen in FIG. 8. This screen presents the user with the list of programs already included in the Always Block Program List 81 and allows the user to navigate to, highlight, as symbolize by the mark 82, and select a program title that the user wishes to remove from the list. Upon selecting the desired program, the system will go back to step 22, showing the screen seen in FIG. 6 with the deleted program removed from the list seen in the display area.

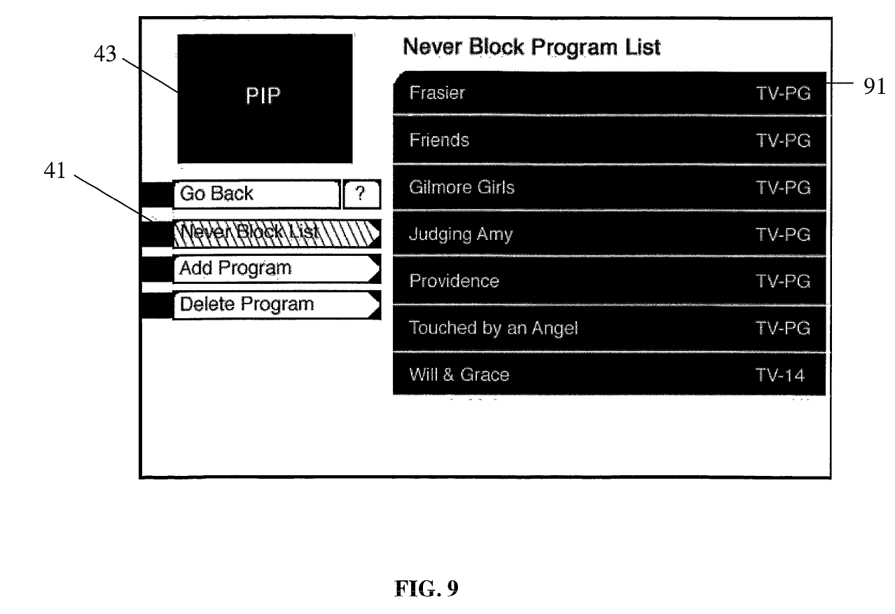

If the user highlights and selects the Never Block List option from the screen shown in FIG. 4, the system proceeds from step 21 to step 22 and the user is presented with a screen similar to that seen in FIG. 9. A list of items that have already been added to the Never Block Program List 91 is displayed, with the options to add a program to this list and to delete a program from this list. If the user had not yet added any programs to the Never Block Program List, the display area on the right would be empty, and the user would only have the option of adding programs to this list.

The screens for adding and deleting programs from the Never Block Program list would appear similar to the screens depicted in FIGS. 7 and 8.

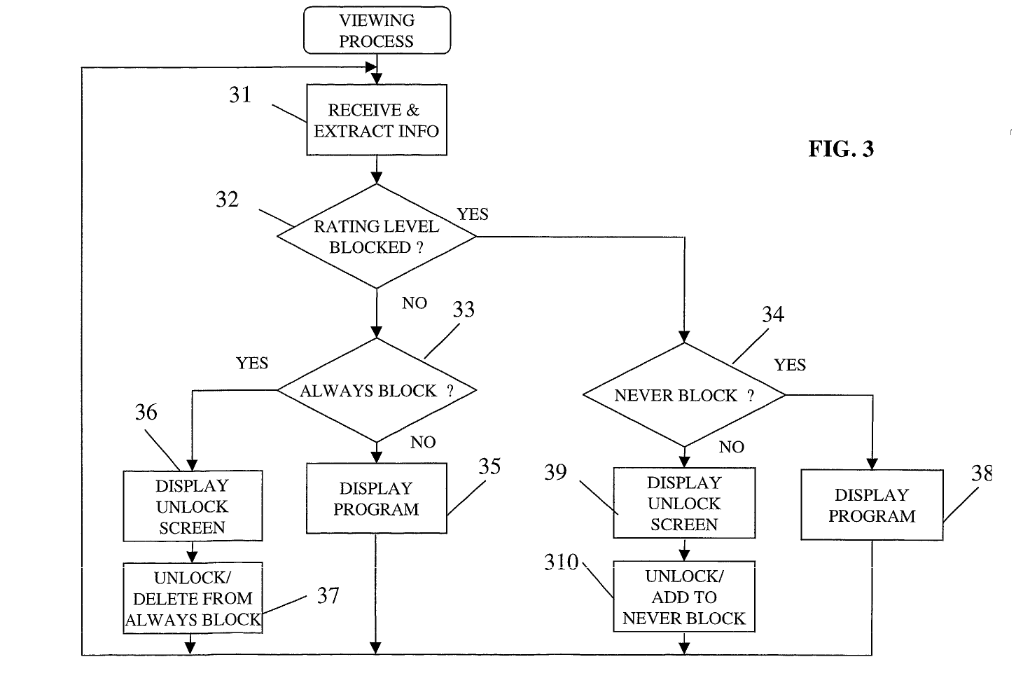

FIG. 3 shows a flow diagram of a method for selectively blocking or enabling the viewing of television programs after the rating limits and rating exceptions have been set up.

From a received television signal information for specifying the recommended rating and identifying the television program is extracted in step 31. In the following step 32 the recommended rating received with the TV signal is compared with the stored rating limits defined by the user. If the recommended rating is below the stored rating limit, the method proceeds in step 33, otherwise in step 34.

In step 33 it is checked whether the television program is included in the Always Block Program List. If this is not the case, the program will be displayed in step 35. On the other hand, if the program is included in the Always Block Program List, the program is blocked in step 36 and the user is presented with a screen informing him that the current program is included in the Always Block Program List. In the following step 37 the user may unlock the system for viewing of the program. In case of a series the user can either enable viewing of only the current episode or of all the following episodes by deleting the program from the Always Block Program List.

A similar processing is performed if the method proceeds from step 32 to step 34. In this case it is checked in step 34 whether the television program is included in the Never Block Program List. If this is the case, the program will be displayed in step 38, otherwise the program is blocked in step 39 and the user is presented with a screen informing him that the current program exceeds a rating limit. In the following step 310 the user may unlock the system for viewing of the current program or in the case of the series the user can enable viewing of all the following episodes by adding the program to the Never Block Program List.

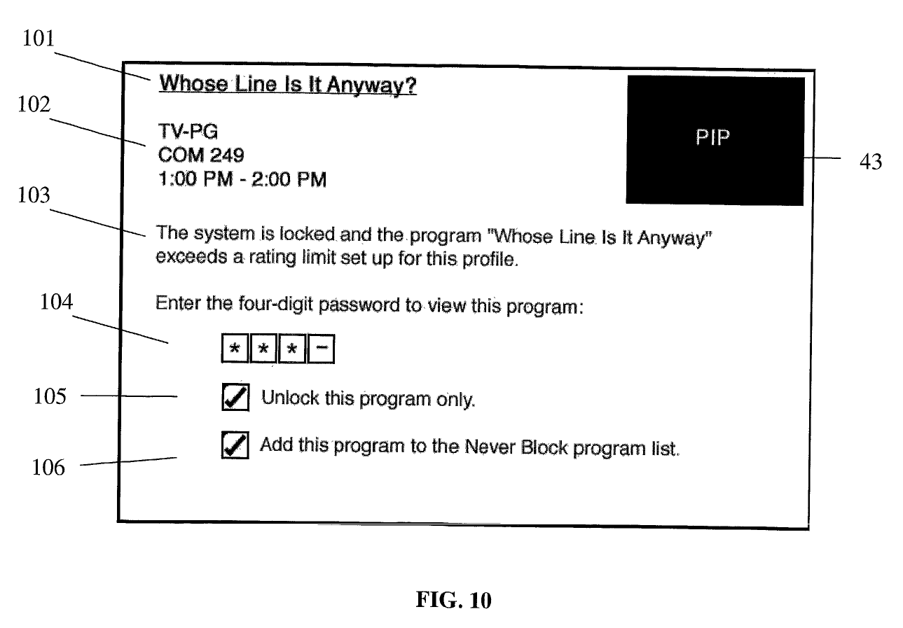

The screen displayed at step 39 is shown in FIG. 10. The title 101 and further information 102 about the current program like the recommended rating, the channel and the broadcasting time is displayed. This information can e.g. be taken from the information stored in an EPG database. Furthermore, the user is asked to enter a four-digit password 104 for viewing the program. Finally, the user may define whether only the current program is to be unlocked, symbolized by the hook 105 and whether the current program shall be added to the Never Block Program List, symbolized by the hook 106.

Though not depicted, while watching video, should the user tune to a program that he would prefer to add to the Always Block Program List or remove from the Never Block Program List, the user would be able to summon a screen that would allow him to amend the respective list.

The invention extends the functionality of rating limits which can be used in consumer electronic devices including, but not limited to, television signal receiving apparatus (e.g., a television receiver with or without a display device), set-top boxes, VCRs, PVRs or DVD players. However, provided that suitable rating limits are specified, the invention can also be used for blocking certain games on game consoles or for content filtering of Internet web sites, chat and news groups and emails.

The invention may be implemented in hardware or software, wherein a software implementation could be part of the operating system but could also be distributed and installed as a separate program.

What is claimed is:

1. A method for selectively controlling access to programs, comprising:
setting a rating limit corresponding to a first user input;
setting an exception to said rating limit corresponding to a second user input;
receiving information for identifying a program and for specifying a rating of said program;
comparing said rating of said program with said stored rating limit;
determining whether an exception to said rating limit has been set for said program identified by said received program identifying information; and
controlling access to said program in response to the results of the steps of comparing and determining.

2. The method in accordance with claim 1, wherein said information for specifying at least one rating of a program and for identifying said program is received together with said program.

3. The method in accordance with claim 1, wherein said programs are television programs and wherein said rating limits are used in a parental control system.

4. The method in accordance with claim 2, wherein said television programs are received as an analogue television signal and said ratings are received embedded in the vertical blanking interval of said analogue television signal.

5. The method in accordance with claim 3, wherein the ratings define the age of the viewer the program is designed for, the degree of a certain program content, or a combination thereof.

6. The method in accordance with claim 1, wherein said exceptions from said rating limits define programs which shall be blocked or enabled independently to said set rating limits.

7. The method in accordance with claim 6, wherein a never block program list specifies certain programs that should never be blocked, even if these programs exceed the rating limits.

8. The method in accordance with claim 6, wherein an always block program list specifies certain programs that should always be blocked, even if these programs do not exceed the rating limits.

9. The method in accordance with claim 6, wherein said exceptions are specified by metadata describing said programs like the program title, actor name, director name or topic.

10. The method in accordance with claim 9, wherein said metadata specifying said exceptions are selected by the user from a dedicated list of metadata.

11. The method in accordance with claim 9, wherein program titles specifying said exceptions are selected by the user from a displayed EPG program schedule.

12. The method in accordance with claim 9, wherein said metadata specifying said exceptions are selected by marking a currently displayed program.

13. The method in accordance with claim 12, wherein the program title of the currently displayed program is stored as exception from said rating limits.

14. The method in accordance with claim 12, wherein an overview of metadata describing the currently displayed program is displayed to the user and wherein one or more of said metadata are selected by the user and stored as exceptions from said rating limits.

15. The method in accordance with claim 6, wherein a set exception is valid for any following episode of a program series.

16. A method for selectively controlling the viewing of television programs, comprising:
setting rating limits in a parental control system for television programs corresponding to first user inputs, wherein said rating limits generally define whether television programs are to be blocked or are enabled for viewing;
setting exceptions from said rating limits for certain television programs corresponding to second user inputs;
storing said rating limits and exceptions from said rating limits for certain television programs;
receiving television programs with embedded information for specifying recommended ratings and for identifying said television program;
extracting said embedded information;
comparing said recommended ratings with said stored rating limits;
checking with said information for identifying said television program whether an exception from said rating limits for certain television programs has been set;
blocking the viewing of a specific television program either if said rating limits indicate that said specific television program is to be blocked and no exception from said rating limits for said specific television program is set or if said exception from said rating limits indicate that said specific television program is to be blocked; and
enabling the viewing of a television program either if said rating limits indicate that said specific television program is not to be blocked and no exception from said rating limits for said specific television program is set or if said exception from said rating limits indicate that said specific television program is not to be blocked.

17. Apparatus for selectively controlling access to programs, comprising:
means for setting a rating limit corresponding to a first user input;
means for setting an exception to said rating limit corresponding to a second user input;
means for receiving information for identifying a program and for specifying a rating of said program;
means for comparing said rating of said program with said stored rating limit;
means for determining whether an exception to said rating limit has been set for said program identified by said received program identifying information; and
means for controlling access to said program in response to the results of the steps of comparing and determining.
